(19) United States
(12) Patent Application Publication
(10) Pub. No.: US 2016/0169677 A1
(43) Pub. Date: Jun. 16, 2016

(54) ROTATION DETECTION SENSOR

(71) Applicant: Samsung Electro-Mechanics Co., Ltd., Suwon-si (KR)

(72) Inventors: Won HAN, Suwon-si (KR); Jong Woon KIM, Suwon-si (KR)

(73) Assignee: Samsung Electro-Mechanics Co., Ltd., Suwon-si (KR)

(21) Appl. No.: 14/930,076

(22) Filed: Nov. 2, 2015

(30) Foreign Application Priority Data
Dec. 12, 2014 (KR) 10-2014-0179523

(51) Int. Cl. G01C 19/5755

(52) U.S. Cl. CPC G01C 19/5755

(57) ABSTRACT

A rotation detection sensor is provided. The rotation detection sensor includes a fixed member spaced apart from a mass body, a first flexible member connecting the mass body and the fixed member to each other in a first direction, a second flexible member connecting the mass body and the fixed member to each other in a second direction perpendicular to the first direction, and membranes connecting the mass body and the fixed member to each other, the second flexible member being disposed between the membranes.

### CROSS-REFERENCE TO RELATED APPLICATION

This application claims the benefit under 35 USC 119(a) of Korean Patent Application No. 10-2014-0179523 filed on Dec. 12, 2014, in the Korean Intellectual Property Office, the entire disclosure of which is incorporated herein by reference for all purposes.

### BACKGROUND

1. Field

The present disclosure relates to a rotation detection sensor.

2. Description of Related Art

Rotation detection sensors are used for various purposes, including the determination of motions of objects such as artificial satellites, missiles, electronic devices, and the like.

Angular velocity sensors measure an amount of Coriolis force applied to its mass body that is adhered to an elastic member such as a membrane, in order to measure angular velocity.

In angular velocity sensors, the mass body is connected to a fixed member by the membrane and a flexible member. However, because the flexible member is disposed in a limited space, a limitation exists on increasing the length of the flexible member, and stress becomes concentrated on the membrane connected to the flexible member. Thus, the rotational rigidity of the mass body is decreased, and noise is generated.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a rotation detection sensor includes a fixed member spaced apart from a mass body, a first flexible member connecting the mass body and the fixed member to each other in a first direction, a second flexible member connecting the mass body and the fixed member to each other in a second direction perpendicular to the first direction, and membranes connecting the mass body and the fixed member to each other, the second flexible member being disposed between the membranes.

The second flexible member may be disposed between the membranes such that the membranes are spaced apart from each other.

A width of the second flexible member may be smaller than a gap between the membranes.

An upper surface of the second flexible member may be disposed between upper and lower surfaces of the membranes.

The general aspect of the rotation detection sensor may further include a detection module disposed on the first flexible member and detecting a displacement of the mass body.

The detection module may include a piezoelectric body and electrodes provided on the piezoelectric body.

The electrodes include a first electrode and a second electrode disposed closer to the mass body than to the first electrode.

The general aspect of the rotation detection sensor may further include electrode wirings disposed on the membranes.

In another general aspect, a rotation detection sensor includes a mass body having slit portions, a fixed member spaced apart from the mass body, flexible members including a first flexible member connecting the mass body and the fixed member to each other in a first direction and a second flexible member connecting the mass body and the fixed member to each other in a second direction, perpendicular to the first direction, the flexible members at least partially disposed in the slit portions, and membranes connecting the mass body and the fixed member to each other, the second flexible member disposed between the membranes.

The slit portions may be recessed inwardly from both sides of the mass body in the second direction.

One end of the second flexible member may be coupled to inner surfaces of the slit portions of the mass body, and the other end thereof may be coupled to the fixed member.

The membranes may connect outer surfaces of the mass body and the fixed member to each other.

A width of the second flexible member may be smaller than a gap between the membranes.

An upper surface of the second flexible member may be disposed between upper and lower surfaces of the membranes.

The general aspect of the rotation detection sensor may further include electrode wirings disposed on the membranes.

Other features and aspects will be apparent from the following detailed description, the drawings, and the claims.

### BRIEF DESCRIPTION OF DRAWINGS

FIG. 1 is a schematic perspective view of an example of a rotation detection sensor.

FIG. 2 is a schematic plan view of the example of the rotation detection sensor illustrated in FIG. 1.

FIG. 3 is a schematic cross-sectional view of the example taken along line A-A′ of FIG. 1.

FIG. 4 is a schematic plan view illustrating degrees of freedom of a mass body according to the example illustrated in FIG. 2.

FIG. 5 is a schematic cross-sectional view illustrating degrees of freedom of a mass body according to the example illustrated in FIG. 3.

FIGS. 6 and 7 are schematic cross-sectional views illustrating the rotation of the mass body of an example of the rotation detection sensor in relation to an X axis, according to the present disclosure.

FIG. 8 is a schematic perspective view of another example of a rotation detection sensor.

FIG. 9 is a schematic plan view of the example of the rotation detection sensor of FIG. 8.

FIG. 10 is a schematic cross-sectional view of the example of the rotation detection sensor taken along line B-B′ of FIG. 6.

FIG. 11 is a schematic plan view illustrating degrees of freedom of the example of a mass body illustrated in FIG. 9.

FIG. 12 is a schematic cross-sectional view illustrating degrees of freedom of the example of a mass body illustrated in FIG. 10.

FIGS. 13 and 14 are schematic cross-sectional views illustrating the rotation of the mass body of another example of a rotation detection sensor in relation to an X axis.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

In the drawings, the shapes and dimensions of elements may be exaggerated for clarity, and the same reference numerals will be used throughout to designate the same or like elements.

In a conventional angular velocity sensor, a mass body is connected to a fixed member by a membrane and a flexible member, but the flexible member is disposed in a limited space. Thus, a limitation exists on increasing the length of the flexible member, and stress becomes concentrated on the membrane that connects to the flexible member, decreasing rotational rigidity of the mass body and potentially generating noise. Therefore, a rotation detection sensor in which the length of the flexible member is increased while alleviating the stress applied to the membrane is desirable.

The present disclosure provides an example of a rotation detection sensor capable of decreasing signal noise and having improved sensitivity.

The present disclosure further provides an example of a rotation detection sensor in which the mass body is provided with slit portions recessed inwardly from both sides thereof in the second direction.

The present disclosure further provides an example of a rotation detection sensor in which the length of a second flexible member may be increased due to spaces formed by slit portions. As a result, the linearity of rotational rigidity of the second flexible member may be enhanced, whereby the sensitivity of the rotation detection sensor may be improved.

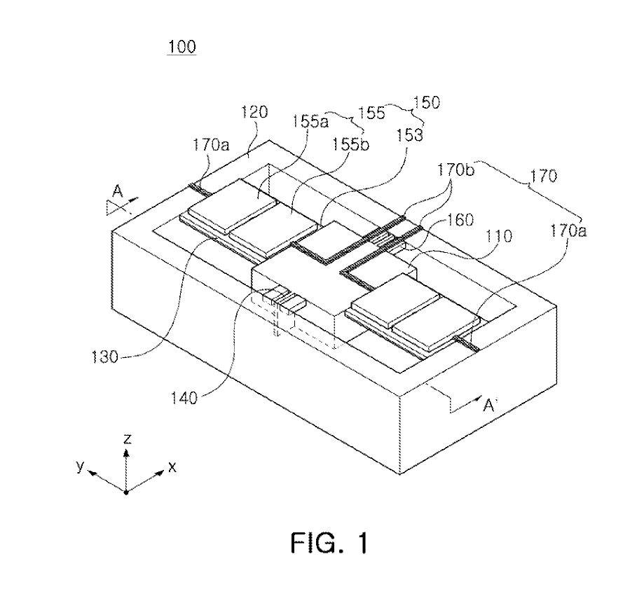

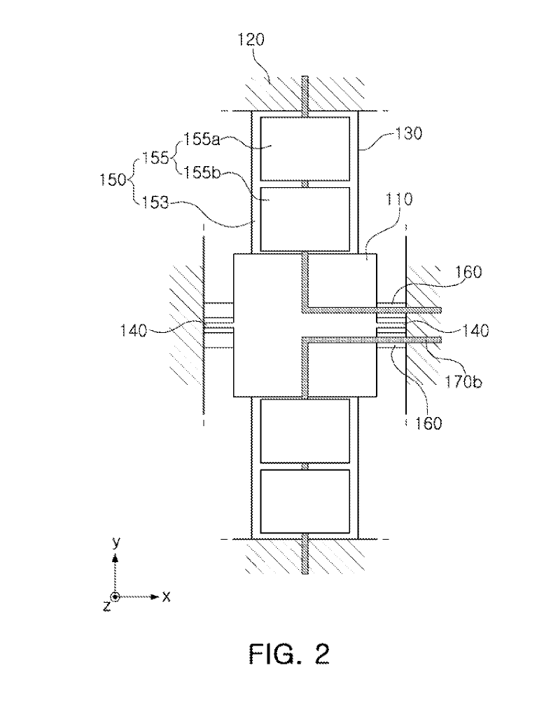

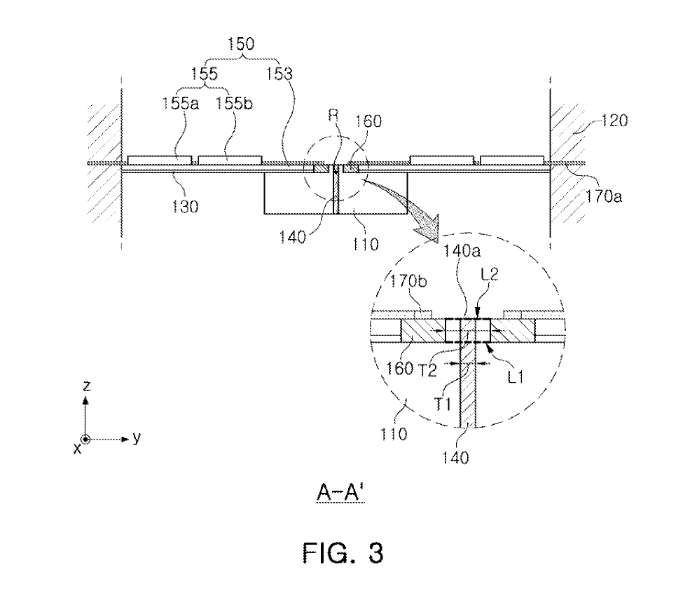

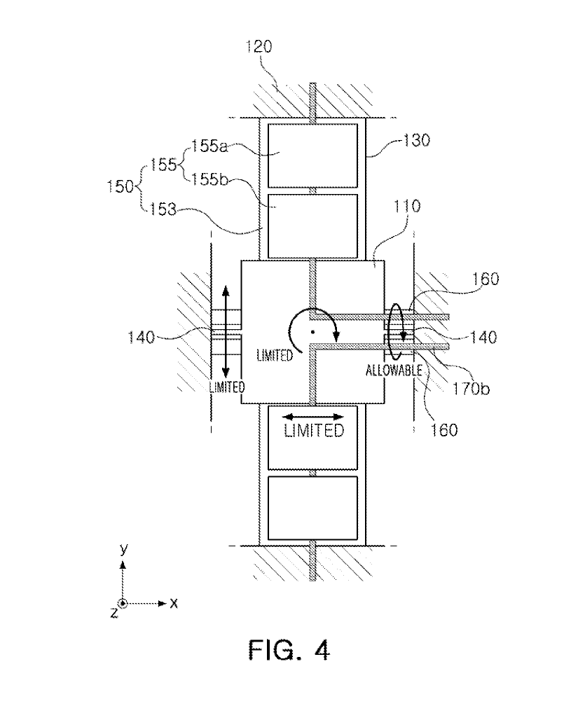

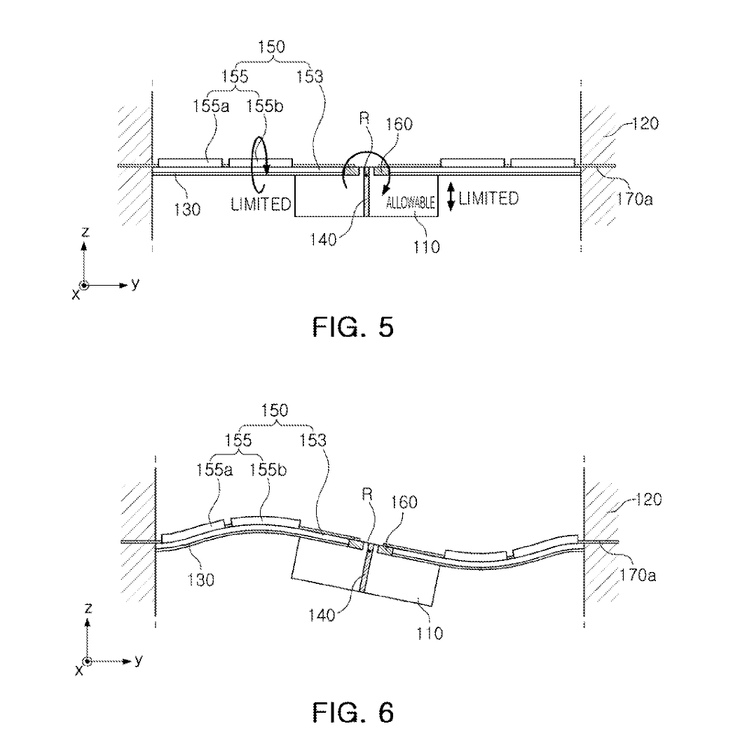

FIG. 1 illustrates a perspective view of an example of a rotation detection sensor; FIG. 2 illustrates a plan view of the example of the rotation detection sensor of FIG. 1; FIG. 3 illustrates a cross-sectional view taken along line A-A′ of FIG. 1; FIG. 4 illustrates a plan view illustrating a degrees of freedom of an example of a mass body illustrated in FIG. 2; and FIG. 5 illustrates a cross-sectional view showing a degrees of freedom of the example of a mass body illustrated in FIG. 3.

Referring to FIGS. 1 through 5, a rotation detection sensor 100 includes a mass body 110, a fixed member 120 disposed to be spaced apart from the mass body 110, flexible members 130 and 140 including a first flexible member 130 connecting the mass body 110 and the fixed member 120 to each other in a first direction and a second flexible member 140 connecting the mass body 110 and the fixed member 120 to each other in a second direction, perpendicular to the first direction, and membranes 160 connecting the mass body 110 and the fixed member 120 to each other and disposed to be spaced apart from each other so that the second flexible member 140 is disposed therebetween.

The mass body 110, which becomes displaced by inertial force, Coriolis force, external force, or the like during the movement of the rotation detection sensor 100, is connected to the fixed member 120 by the first and second flexible members 130 and 140. In this example, the mass body 110 may be displaced in relation to the fixed member 120 by bending of the first flexible member 130 and twisting of the second flexible member 140 when force, such as external force, acts thereon.

For example, the mass body 110 may rotate about an X axis. Details thereof will be provided below.

Terms with respect to directions will be defined. As viewed in FIG. 1, an X axis direction refers to a width direction of the rotation detection sensor, a Y axis direction refers to a length direction of the rotation detection sensor, and a Z axis direction refers to a thickness direction of the rotation detection sensor.

Meanwhile, although the mass body 110 is illustrated as having a quadrangular pillar shape, in another example, the mass body may have any shape well-known in the related art, such as a cylindrical shape and a fan shape.

The fixed member 120 supports the first and second flexible members 130 and 140 to provide a space in which the mass body 110 may be displaced, and may become a basis when the mass body 110 is displaced.

In the illustrated examples, the fixed member 120 is disposed to enclose the mass body 110, and the mass body 110 is disposed in a central portion of the fixed member 120.

The flexible members 130 and 140 include the first flexible member 130 connecting the mass body 110 and the fixed member 120 to each other in first direction and the second flexible member 140 connecting the mass body 110 and the fixed member 120 to each other in the second direction perpendicular to the first direction.

In this example, the first flexible member 130 connects the mass body 110 and the fixed member 120 to each other in the Y axis direction, and the second flexible member 140 connects the mass body 110 and the fixed member 120 to each other in the X axis direction. Therefore, the first and second flexible members 130 and 140 are disposed to be perpendicular to each other.

The first and second flexible members 130 and 140 connect the mass body 110 and the fixed member 120 to each other on both sides of the mass body 110, respectively.

In addition, a width of the first flexible member 130 in the X axis direction is greater than a thickness thereof in the Z axis direction, and a thickness of the second flexible member 140 in the Z axis direction is greater than a width thereof in the Y axis direction.

Since the thickness of the second flexible member 140 in the Z axis direction is larger than the width thereof in the Y axis direction, the mass body 110 is limited in being rotated about a Y axis or being translated in the Z axis direction, but is relatively free to rotate about the X axis.

Since the rigidity of the second flexible member 140 at the time of rotation about the Y axis is greater than the rigidity of the second flexible member 140 at the time of rotation about the X axis, the mass body 110 may freely rotate about the X axis, but may be limited in being rotated about the Y axis.

Similarly, since the rigidity of the second flexible member 140 at the time of translation in the Z axis direction is greater than the rigidity of the second flexible member 140 at the time of rotation about the X axis, the mass body 110 may be freely rotated about X axis, but may be limited in its translation in the Z axis direction.

Meanwhile, since the rigidity of the first flexible member 130 in the Y axis direction is relatively large, the mass body 110 is limited in its rotation about a Z axis or in its translation in the Y axis direction. In addition, since the rigidity of the second flexible member 140 in the X axis direction is relatively high, the mass body 110 may be limited in its translation motion in the X axis direction.

As a result, due to the above-described characteristics of the first and second flexible members 130 and 140, the mass body 110 may rotate about the X axis, but may have limitations in being rotated about the Y or Z axis or being translated in the Z, Y, or X axis direction.

As described above, the mass body 110 may be rotated about the X axis, but may be limited in being moved in other directions. Therefore, a displacement of the mass body 110 may be generated with respect to only the force applied in a desired direction (rotation about the X axis).

As a result, the rotation detection sensor 100 according to the present example may have the effects of preventing the generation of crosstalk at the time of measuring acceleration or force and of removing interference of a resonance mode at the time of measuring angular velocity.

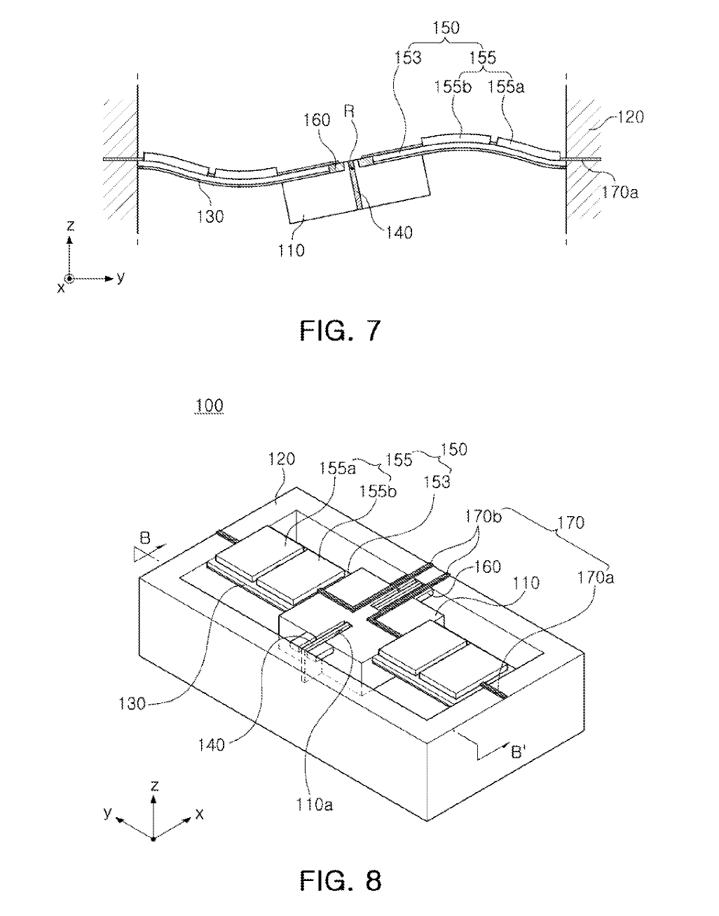

FIGS. 6 and 7 are schematic cross-sectional views illustrating the rotation of the mass body of the rotation detection sensor in relation to an X axis, according to an example of the present disclosure.

Referring to FIGS. 6 and 7, because the mass body 110 is rotated about the X axis, which is a rotation axis R, bending stress, which is a combination of compression stress and tension stress, may be generated in the first flexible member 130, and twisting stress in relation to the X axis may be generated in the second flexible member 140.

In this example, a detection module 150 detects degrees of deformation of the flexible members 130 and 140 in order to measure an angular rotational velocity of the mass body 110.

The membranes 160 connects the mass body 110 and the fixed member 120 to each other. Further, referring to FIG. 6, two membranes 160 are disposed to be spaced apart from each other such that the second flexible member 140 is disposed therebetween.

In other words, the two membranes 160 may be disposed to be spaced apart from each other in the Y axis direction, in relation to the second flexible member 140.

In addition, a thickness of the membrane 160 in the Z axis direction may be smaller than that of the second flexible member 140 in the Z axis direction.

The membranes 160 may be disposed to be spaced apart from an upper portion of the second flexible member 140 in order to significantly decrease an influence on the rotation of the mass body 110 in relation to the X axis, and be disposed on the same level as the first and second flexible members 130 and 140 in relation to the Z axis.

Therefore, the membranes 160 and the flexible parts 130 and 140 may have a ‘T’ shape in relation to a Y-Z plane.

In this example, at least a portion of the upper portion of the second flexible member 140 is disposed between the membranes 160. That is, an upper surface 140a of the second flexible member 140 is disposed between upper and lower surfaces L2 and L1 of the membranes 160.

In addition, a width T1 of the second flexible member 140 in the Y axis direction is smaller than a gap T2 between the membranes 160 in the Y axis direction. Therefore, the second flexible member 140 and the membranes 160 are disposed to be spaced apart from each other by a predetermined gap in the Y axis direction, and does not come into contact with each other even when the mass body 110 is rotated about the X axis.

In addition, by disposing the second flexible member 140 and the membranes 160 to be spaced apart from each other, the illustrated example of the rotation detection sensor 100 may have the effect of decreasing non-uniform stress applied to the membranes 160 in a case in which the mass body 110 is rotated and of reducing signal noise.

In other words, when the membranes 160 and the second flexible member 140 contact each other, in a case in which the second flexible member 140 is twisted by the rotation of the mass body 110, the non-uniform stress acts on the membranes 160, which affect electrode wirings 170 disposed on the membranes 160, and thus, signal noise may be generated.

Therefore, in the rotation detection sensor 100 according to one example of the present disclosure, the membranes 160 is disposed spaced apart from the upper portion of the second flexible member 140, such that a contact between the membranes 160 and the second flexible part 140 is prevented, whereby an influence of the membranes 160 on rotation characteristics of the mass body 110 is significantly decreased and signal noise due to the non-uniform stress acting on the membranes 160 is significantly decreased.

Meanwhile, the electrode wirings 170 are disposed on the membranes 160. The electrode wirings 170 may electrically connect a detection module 150 and an external control unit (not illustrated) to each other to allow displacement information of the mass body 110 measured by the detection module 150 to be transferred to the external control unit.

The detection module 150 measures bending of the first flexible member 130 and twisting of the second flexible member 140 to detect displacement of the mass body 110 rotated about the X axis, and be disposed on the first flexible member 130.

The detection module 150 includes a piezoelectric body 153 and electrodes 155 formed on the piezoelectric body 153. The electrodes 155, which measure electric charges generated in the piezoelectric body 153, may be electrically connected to the external control unit through the electrode wirings 170 extended to the fixed member 120.

The electrode wirings 170 extends from the electrodes 155 to the fixed member 120 through the membranes 160. The electrodes 155 and the electrode wirings 170 may have various forms in addition to that illustrated in FIG. 7.

For example, the electrodes 155 include a first electrode 155a formed closely to the fixed member 120 on the first flexible member 130 and a second electrode 155b formed closely to the mass body 110 as compared with the first electrode 155a.

In addition, the electrode wirings 170 includes a first wiring 170a directly extended from the first electrode 155a to the fixed member 120 and a second wiring 170b extended from the second electrode 155b to the fixed member 120 through the membrane 160.

Meanwhile, as described above, the second wiring 170b of the electrode wirings 170 extends to the fixed member 120 through an upper portion of the membrane 160. However, in a case in which the non-uniform stress acts on the membrane 160, the second wiring 170b may be affected by the non-uniform stress, causing signal noise.

However, in the rotation detection sensor 100 according to one example, the membranes 160 and the second flexible member 140 are disposed to be spaced apart from each other, whereby the stress applied to the membranes 160 may be significantly decreased and signal noise generated due to the stress acting on the second wiring 170b may be finally decreased.

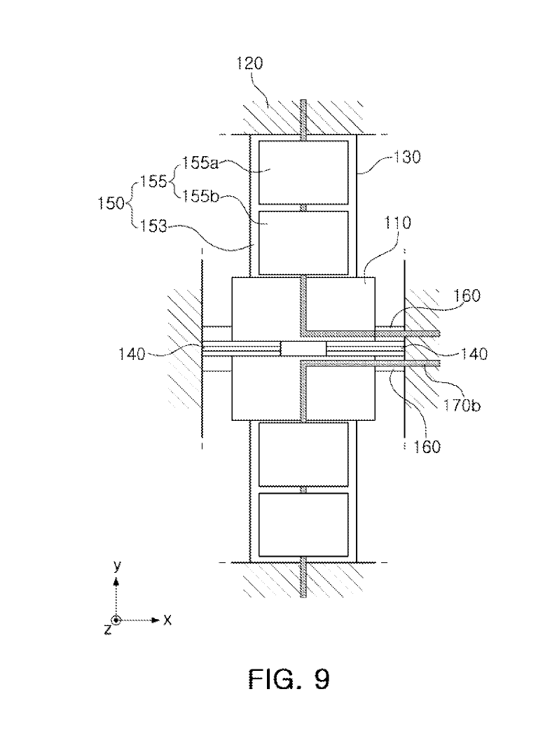

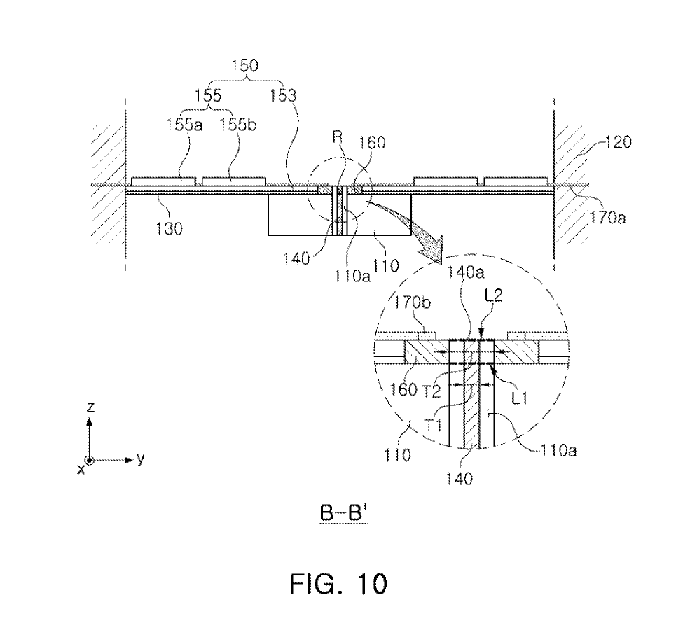

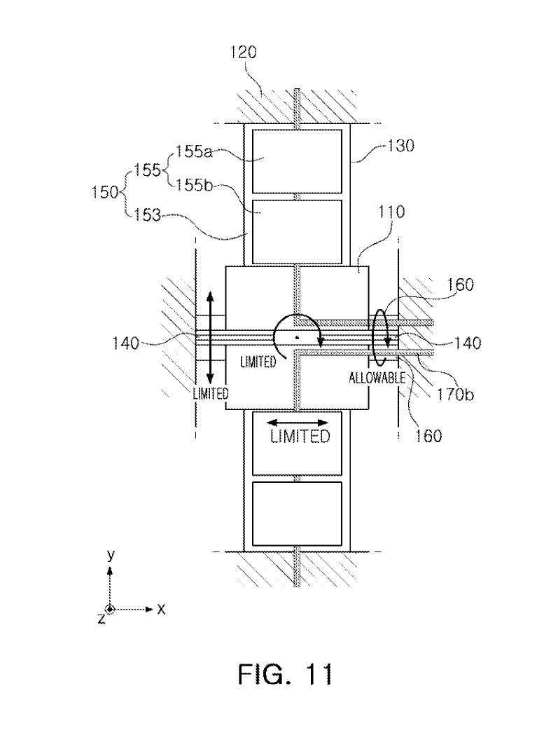

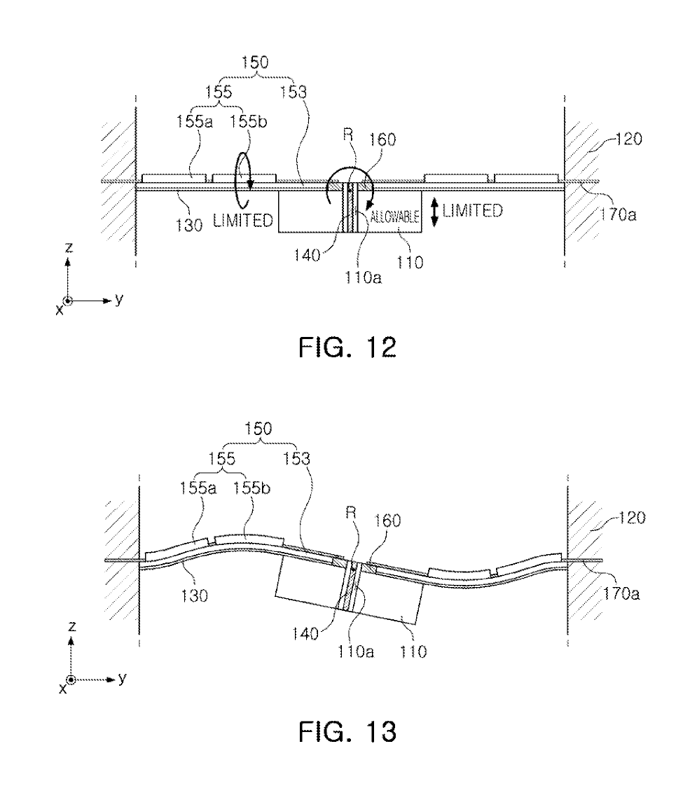

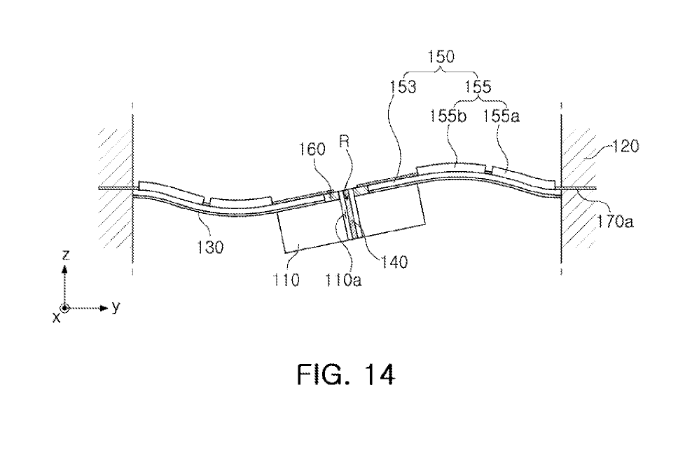

FIG. 8 illustrates a schematic perspective view of an example of a rotation detection sensor according to the present disclosure; FIG. 9 illustrates a plan view of the rotation detection sensor of FIG. 8; FIG. 10 illustrates a cross-sectional view taken along line B-B′ of FIG. 8; FIG. 11 is a plan view illustrating a degrees of freedom of a mass body illustrated in FIG. 9; FIG. 12 is a cross-sectional view illustrating a degrees of freedom of a mass body illustrated in FIG. 10; and FIGS. 13 and 14 are schematic cross-sectional views illustrating the rotation of the mass body of the rotation detection sensor in relation to an X axis, according to another example of the present disclosure.

Referring to FIGS. 8 through 14, the example of a rotation detection sensor 100 includes a mass body 110 provided with slit portions 110a recessed inwardly, a fixed member 120 disposed to be spaced apart from the mass body 110, flexible members 130 and 140 including a first flexible member 130 connecting the mass body 110 and the fixed member 120 to each other in a first direction and a second flexible member 140 connecting the mass body 110 and the fixed member 120 to each other in a second direction, perpendicular to the first direction and at least partially disposed in the slit portions 110a, and membranes 160 connecting the mass body 110 and the fixed member 120 to each other and disposed to be spaced apart from each other so that the second flexible part 140 is disposed therebetween.

That is, all components of the rotation detection sensor 100 except for the mass body 110 and the second flexible member 140 are the same as those of the rotation detection sensor according to the previous example illustrated in FIGS. 1 through 7.

Therefore, a detailed description of the same components will be omitted.

Referring to FIG. 8, the mass body 110 of the rotation detection sensor 100 is provided with the slit portions 110a recessed inwardly.

The slit portions 110a is recessed inwardly from both sides of the mass body 110 in the X axis direction to which the second flexible member 140 is connected. Therefore, a cross section of the mass body 110 in relation to an X-Y plane has an ‘H’ shape.

In addition, outer surfaces of the mass body 110 in which the slit portions 110a are formed are provided with the membranes 160 disposed to be spaced apart from each other and having the slit portions 110a disposed therebetween. That is, the membranes 160 connect the outer surfaces of the mass body 110 having the slit portions 110a to the fixed member 120.

The second flexible member 140 connects the mass body 110 and the fixed member 120 to each other, and one end of the second flexible member 140 is coupled to inner surfaces of the slit portions 110a of the mass body 110 and the other end of the second flexible member 140 is coupled to the fixed member 120.

That is, the second flexible member 140 included in the rotation detection sensor 100 has an increased length in the X axis direction due to spaces formed by the slit portions 110a.

As a result, the linearity of rotational rigidity of the mass body 110 at the time of rotation of the mass body 110 may be enhanced to improve sensitivity of the rotation detection sensor 100.

As set forth above, according to the present example, the rotation detection sensor may have reduced signal noise and improved sensitivity.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A rotation detection sensor comprising:
a fixed member spaced apart from a mass body;
a first flexible member connecting the mass body and the fixed member to each other in a first direction;
a second flexible member connecting the mass body and the fixed member to each other in a second direction perpendicular to the first direction; and
membranes connecting the mass body and the fixed member to each other, the second flexible member being disposed between the membranes.

2. The rotation detection sensor of claim 1, the second flexible member is disposed between the membranes such that the membranes are spaced apart from each other.

3. The rotation detection sensor of claim 1, wherein a width of the second flexible member is smaller than a gap between the membranes.

4. The rotation detection sensor of claim 1, wherein an upper surface of the second flexible member is disposed between upper and lower surfaces of the membranes.

5. The rotation detection sensor of claim 1, further comprising a detection module disposed on the first flexible member and detecting a displacement of the mass body.

6. The rotation detection sensor of claim 5, wherein the detection module comprises a piezoelectric body and electrodes provided on the piezoelectric body.

7. The rotation detection sensor of claim 6, wherein the electrodes comprise a first electrode and a second electrode disposed closer to the mass body than to the first electrode.

8. The rotation detection sensor of claim 1, further comprising electrode wirings disposed on the membranes.

9. A rotation detection sensor comprising:
a mass body having slit portions;
a fixed member spaced apart from the mass body;
flexible members comprising a first flexible member connecting the mass body and the fixed member to each other in a first direction and a second flexible member connecting the mass body and the fixed member to each other in a second direction, perpendicular to the first direction, the flexible members at least partially disposed in the slit portions; and
membranes connecting the mass body and the fixed member to each other, the second flexible member disposed between the membranes.

10. The rotation detection sensor of claim 9, wherein the slit portions are recessed inwardly from both sides of the mass body in the second direction.

11. The rotation detection sensor of claim 10, wherein one end of the second flexible member is coupled to inner surfaces of the slit portions of the mass body, and
the other end thereof is coupled to the fixed member.

12. The rotation detection sensor of claim 10, wherein the membranes connect outer surfaces of the mass body and the fixed member to each other.

13. The rotation detection sensor of claim 10, wherein a width of the second flexible member is smaller than a gap between the membranes.

14. The rotation detection sensor of claim 10, wherein an upper surface of the second flexible member is disposed between upper and lower surfaces of the membranes.

15. The rotation detection sensor of claim 10, further comprising electrode wirings disposed on the membranes.
